(19) United States
(12) Patent Application Publication
(10) Pub. No.: US 2006/0210675 A1
(43) Pub. Date: Sep. 21, 2006

(54) Canned pet food with sliced meat analogue

(75) Inventor: Catriona Gifford, Wodonga (AU)

Correspondence Address: FULBRIGHT & JAWORSKI, LLP, 1301 MCKINNEY, SUITE 5100, HOUSTON, TX, 77010-3095, US

(73) Assignee: Mars Incorporated, McLean, VA (US)

(21) Appl. No.: 10/535,119

(22) PCT Filed: Nov. 18, 2003
(86) PCT No.: PCT/AU03/01542

§ 371 Date: Mar. 8, 2006

(30) Foreign Application Priority Data
Nov. 18, 2002 (AU) 2002952720

(51) Int. Cl. A23B 7/148

(52) U.S. Cl. 426/106

(57) ABSTRACT

Disclosed is a packaged pet food product that includes two or more slices of meat or meat analogue material in a sauce or gel, wherein said slices are arranged in a rigid or semi-rigid container, such as a can or tray, in a stacked or shingled relationship side-by-side that is immediately apparent upon opening of the container.

### TECHNICAL FIELD

The invention relates to the field of commercial pet food manufacture. In particular it relates to pet food products packaged in rigid and semi-rigid containers like cans, trays, pouches and the like, which include meat or meat analogue materials. The invention also relates to methods for manufacturing same.

### BACKGROUND OF THE INVENTION

Food manufacturers, including commercial canned pet food manufactures, are continuously challenged to find ways to present an appetizing and authentic looking food product at minimized raw material costs. One area of particular endeavor has been the goal of producing attractive meat-based products that convey ‘human food’ aesthetics to the purchaser of premium-branded commercial pet food products.

A product format of particular popularity for its ability to evoke the aesthetics of a human food casserole is the ‘chunks in sauce’ format. This involves placing chunks of meat, or more commonly meat analogue, in a fluid gravy. The gravy may be transparent or opaque. The aesthetic desirability of such products depends greatly on the appearance of the meat or meat analogue material - its size, shape, texture etc. Whilst some cheaper meat cuts may have found use in pet food canning in the past, nowadays the ‘meaty’ -looking component of such products is provided by so called meat analogues, which are substantially cheaper to manufacture than ‘real’ meat cuts.

The most basic attempts to produce a meat-like ‘chunk’, or ‘meat analogue’ have involved the fine grinding of meat by-products such as liver, lungs and other trims obtained from commercial slaughter operations, with cereals and other binders, followed by heat and/or gel or binder setting. The set material may then be cut into desired shapes, such as cubes, and mixed into a canned food product. Such techniques are very well known in the pet food manufacturing and are successfully used for many volume-selling canned pet foods.

However, for some pet food products, in particular the premium and ‘super-premium’ products, such analogues do not necessarily provide a suitable product aesthetic. These basic analogues in particular do not present an appearance of premium meat, nor of care in

Docket No.: HO-P03175USO preparation and presentation: qualities which are highly valued in ‘super premium’ pet food products. Typically, these analogues are formed at very high production rates, are cut into roughly cubic shapes and mixed relatively randomly into the canned product. While this may be an acceptable product format of a lower-priced ‘simple and hearty’ style product, this aesthetic does not tend to impress the buyers of higher-end premium and super-premium pet foods.

One approach that has been taken to provide a suitable analogue for premium canned pet foods is to use cereal-based extruded chunks. Such materials tend to have the desired fibrous internal texture of real meat, due to the nature of the extrusion process, and tend to be less likely to produce cook out. However, cereal-based analogues often do not have the desired innate palatability that is required of premium-branded products.

A superior meat analogue is described in WIPO Patent Document No. WO00/69276, by Effem Foods Pty Ltd. That document discloses an extruded meat analogue of high protein content that has excellent meat-like internal texture and suitable palatability for inclusion in premium pet foods. In particular, this kind of analogue does not produce the cloudy ‘cook-out’ observed in the traditional analogues.

However, due to its high strength ex-extruder, there may be difficulties in cutting or dicing this material in a sufficiently controlled manner for it to resemble, for example, a carefully prepared diced or sliced piece of steak, carefully shredded chicken meat strings and the like. The shredded product produced by the process described in WO 00/69276 tends to display a range of sizes and shapes that without additional handling would make them unsuitable for high-end, visually appealing pet food products.

### BRIEF SUMMARY OF THE INVENTION

Therefore, it is an object of the present invention to provide a premium pet food product that conveys an impression of care in preparation and presentation.

According to one aspect of the invention, there is provided a packaged pet food product that includes two or more slices of meat or meat analogue material in a sauce or gel, wherein said slices are arranged in a rigid or semi-rigid container, such as a can or tray, in a stacked or shingled relationship side-by-side that is immediately apparent upon opening of the container.

Preferably, relatively thin slices of substantially consistent appearance and surface size are employed, wherein these are arranged like shingles thereby to display a carefully stacked food presentation.

The use of relatively thin slices of meat analogue in a tray product tends to convey the impression of care in preparation of the food, due to the apparent care that must be used in preparing such items and placing them in the tray. By ‘relatively thin’ is meant slices that have a thickness of no more than 25% of the smallest dimension of either the length or the width of the analogue material. Even more preferably, the thickness is no more than 15% of the smallest dimension of either the length or the width of the analogue material, as this provides a particularly favorable aesthetic.

In another embodiment, the meat or meat analogue product may consist of a loaf that has been sliced and placed in a pet food tray such that the individual slices remain upright in side-by-side arrangement. The individual slices may in this case be relatively thick.

In yet another embodiment, the packaged pet food product may incorporate slices of different types of meat, e.g. chicken, pork, beef or meat analogue products, that are interleaved and stacked or shingled in alternative order. Such arrangement will add visual attractiveness to such product, and simultaneously provide the pet with a more varied meat choice.

It will be appreciated by those skilled in the art that the canned pet food may additionally include other food materials, such as vegetables, rice, pasta or other desirable inclusions that will equally be placed in the container in a manner that maximizes a visually appealing appearance to the consumer upon opening of the lid.

The sauce or gel incorporated in the pet food product may be based on any one of a number of materials that are well known in the art for this purpose, including but not limited to gelatinized starches such as waxy maize starch, hydrated gums such as carrageenan, locust bean and xanthan, or other materials such as agar agar. It will be appreciated by those skilled in the art that use of the word ‘canned’ carries reference not only to cylindrical steel cans, but also to other packages that are capable of containing such foods for the purposes of commercial sterilization, pasteurization, ultra high pressure treatment with chilled distribution and similarly micro-biological deactivation treatments, such as substantially square or rectangular aluminum trays and pouches made from flexible materials.

In a particularly advantageous embodiment, the canned pet food contains a plurality of meat analogue slices as described above, wherein the slices are arranged in a stack of partially overlapping individual slices, and wherein this stack of slices is arranged in the can such that at least part of the majority of each of the individual slices is visible upon opening the can. This added aspect of careful arrangement of the apparently carefully prepared slices serves to further enhance the impression of care in preparation of the pet food product. Preferably the number of slices in the can is between 3 and 20, while particularly favorable results have been observed where the number of slices in the can is between 5 and 10, and preferably where 7 slices are included.

While it will be appreciated that any size chunk may be used to provide a pet food product embodying the invention, provided the above identified arrangement of individual slices and preferred relationship between thickness and overall size is maintained, a particularly advantageous analogue size for incorporation in trays or cans containing approximately 85 g-100 g of product is 19-26 mm width, 43-52 mm length and 2-7 mm thickness. Of course larger size trays will allow use of sliced chunks of other sizes.

In another aspect of the invention there is provided a method of manufacturing packaged pet food products, in particular pet food products in a tray with a removable peel-off lid, wherein slices or discretely apportioned pieces of meat or meat analogue product are either individually or jointly placed into the tray in a side-by-side stacked or shingled arrangement that is visually noticeable upon lid removal being effected. Other solid food constituents like vegetables, rice, pasta and similar may preferably be placed or filled into the tray at locations voided by the meat or meat analogue components. A gel or other sauce may be filled into the tray either directly subsequent to meat stacking being effected or after any additional food product has been filled into the tray.

The nature of the invention and other aspects thereof will be further explained using a specific, non-limiting example of a trayed pet food product incorporating relatively thin slices of a meat analogue material according to the invention.

### BRIEF DESCRIPTION OF THE DRAWINGS

FIG. 1a, 1b, 1c, 1d and 1e illustrate different pet food products in accordance with the present invention.

FIG. 2 is a schematic flow diagram of a process for preparing a proteinaceous meat analogue.

### DETAILED DESCRIPTION OF THE INVENTION

A super-premium ‘beef and vegetables in gravy’ pet food product in an aluminum tray, according to the invention, was prepared.

Firstly, a steak analogue product was prepared. The overall formulation of the analogue product is given in Table 1.

TABLE 1

| Ingredient | mass % |
|---|---|
| Fibrous Proteinaceous Extruded | 40 |
| Chunk | |
| Mechanically De-boned Chicken | Approx. 50 |
| Meat (MDM) | |
| Binders | 3 |
| Water | 7 |
| Red Iron Oxide | 0.02 |

The fibrous extruded material was obtained as per the formulation and process described in WIPO patent document no. WO 00/69276 by Effem Foods Pty Ltd. For this application, it was shredded to an approximate size corresponding to the ranges: height range from 0.5-10 mm, width range from 5-30 mm, length range from 20-80 mm.

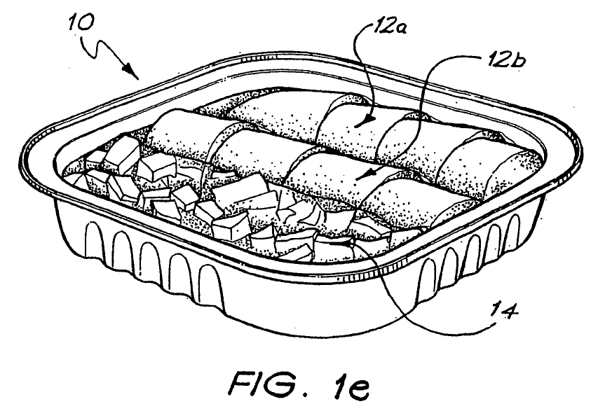

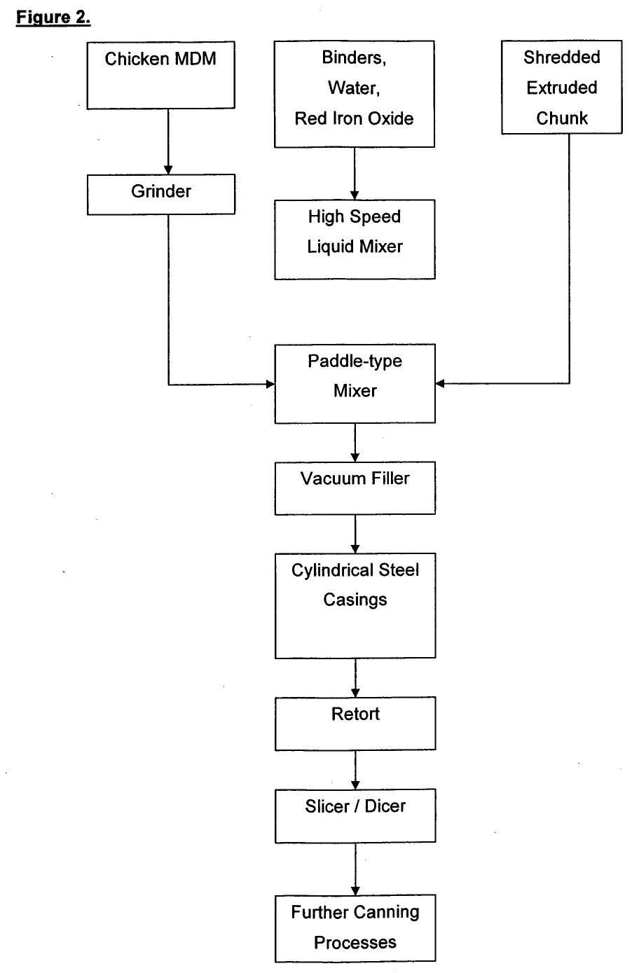

The analogue was prepared according to the process flow shown in FIG. 2. Firstly, the water, binders, and red iron oxides are mixed in a high-speed liquid mixer. The binders serve to hold the structure of the analogue together, while the iron oxides provide an authentic color to the analogue. The MDM was ground in a Weiler-type meat grinder having a hole plate size in the range 2-10 mm.

Then the mixed liquid, the ground meats and the extruded material were transferred to a horizontal paddle blender and mixed until relatively homogeneous.

This mixture was then filled into steel casings, preferably having a rectangular cross-section of about 50 mm by 100 mm. It will be appreciated by those skilled in the art that any desirable shape and size may be used. The filling was accomplished via a vacuum filler of the type commonly used in small goods manufacturing.

The filled and sealed casings were placed on retort racks and thermally processed in a retort at a temperature of 95° C. for approximately 60 minutes. The thermal processing causes the protein matrix present in the mix to denature and thereby bind the extruded chunk. The thermal processing also tends to reduce the likelihood that further material will be expressed by the analogue as it is further processed during the sterilization of the canned products in which it is to be included, causing ‘cook-out’ cloudiness in the sauce.

After thermal processing, and optional chilled storage, the casing was removed and the analogue material was cut to a size of 19-26 mm width, 43-52 mm length and 2-7 mm thickness. These slices were collected in stacks of seven. These stacks were then laid rolled back at an angle of approximately 45°, in order to present the appearance from above of mutually overlapping layers of sliced meat, as per the slices of a sliced loaf of bread that are allowed to fall over by gravity, i.e. a shingled appearance.

These ‘slumped’ stacks were then picked up and placed into an aluminum retort tray of approximately square shape. The approximate size of the tray was 85 mm×85 mm ×25 mm, the approximate mass of meat analogue added to the tray was approximately 80 g (for a 100 g tray). The meat analogue covered approximately 75% of the area of the tray base.

Vegetable material was then added to the remaining 25% open space in the tray, in order to provide nutritional cues and further enhance the appearance of the product. This vegetable material was diced to approximately 6 mm×6 mm×6 mm, and was selected from carrot, roma beans, yellow capsicum, broccoli and potato. Other suitable vegetable materials may be used if desired. The total vegetable inclusion in the tray was approximately 10- 15% by mass.

Separately, a gravy was prepared having a composition as given in Table 2.

TABLE 2

| Ingredient | mass % |
|---|---|
| Tapioca Starch | 3.1 |
| Guar gum | 0.8 |
| Water | 96.1 |

This gravy was made up in a Silverstone-type high speed liquid mixer of the kind very well-known in the art. This gravy was then added to the tray to make up the mass of product to approximately 100 g.

The tray was then sealed and retorted to achieve commercial sterility. Upon opening, the overlapping meat analogue slices resemble premium steak that has been carefully sliced and carefully placed in the tray, giving the overall product a highly pleasing and appetizing appearance that is prized by the customers of premium pet food products.

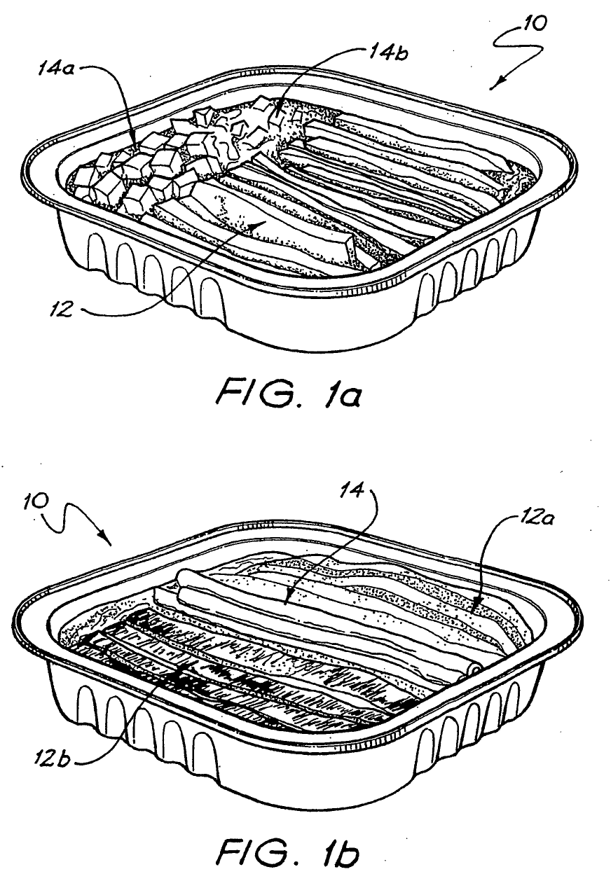

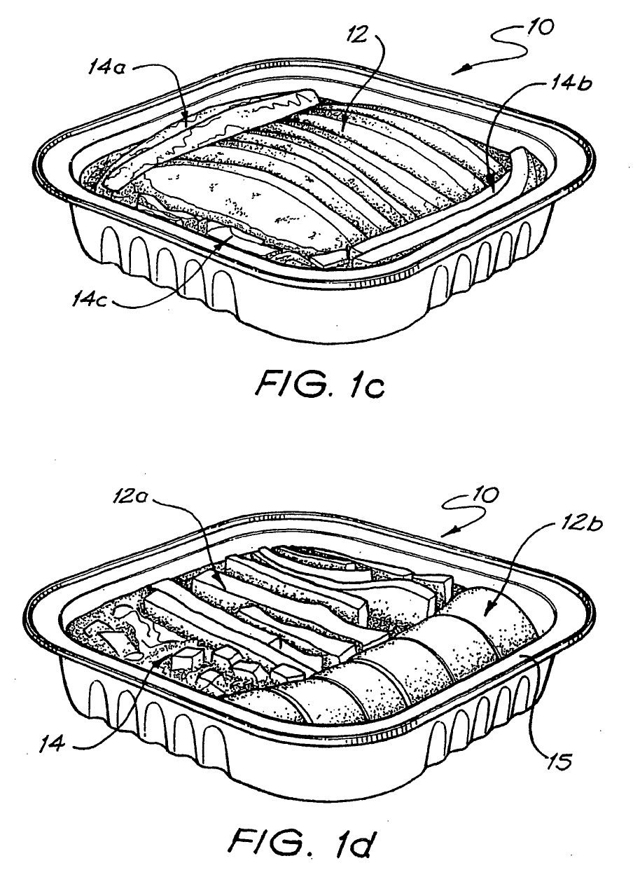

FIGS. 1a to 1c show different embodiments of a trayed pet food product 10 manufactured in accordance with the present invention. In the figures, meat analogue slices are identified at 12; it will be noted that the trays contain different types of meat analogues and vegetables in different arrangement.

In FIG. 1a, thinly sliced meat analogue product (16 slices) resembling thickly sliced ham is used, the side-by-side stacked slices remaining almost vertical in orientation. At 1a and 14b are identified diced carrots and sliced green beans, respectively, arranged in discrete zones to one side of the meat stack. A transparent gel gravy embeds and covers all solid products.

In FIG. 1b, two stacks of different types of sliced meats, e.g. beef analogue and chicken meat, are used, whereas green bean strings having a length comparable to the side dimension of the tray are arranged as a visual barrier between the meat stacks 12a and 12b. Again, a clear gel embeds all solid components 12a, 12b and 14.

In the embodiment of FIG. 1c, 6 slices of meat-loaf-like analogue product 12 are located in the centre of the tray, small capsicum slices 14c are arranged at a terminal end of the meat stack, and carrot sticks 14b and green bean strings 12a are arranged on either side in a visually appealing, multi-color configuration. It will be noted that the stacked meat loaf slices are inclined and shingled.

In the embodiment of FIG. 1d, a sausage-like shaped meat analogue 12b is thickly sliced and arranged adjoining a side wall of the tray 15, whereas a stack of 9-10 thin slices of another type of meat analogue 12a is placed to one side of the first stack, the small remaining squarish pocket being filled with sliced/diced vegetables 14 in gravy.

FIG. 1e shows an embodiment similar to that of FIG. 1d, wherein 2 sausage-like-shaped meat loaf analogue products 12a, 12b are arranged side-by-side and sliced into 4 relatively thick pieces each, the remainder of the tray being again filled with diced/sliced comminuted vegetables 14 in gravy.

It will be understood that numerous variations of the composition of the pet food product according to the invention are possible, while nevertheless remaining within the spirit and scope of the invention.

1. A packaged pet food product comprising:
two or more slices of meat or meat analogue material in a sauce or gel, wherein said slices are arranged in a rigid or semi-rigid container, in a stacked or shingled relationship side-by-side that is apparent upon opening of the container.

2. The pet food of claim 1, wherein said slices are relatively thin slices of substantially consistent appearance and surface size; and wherein said slices are arranged like shingles thereby to display a carefully stacked food appearance.

3. The pet food of claim 2, wherein said slices have a thickness of no more than 25% of any other dimension of the analogue material.

4. The pet food of claim 3, wherein said slices have a thickness of no more than 15% of any other dimension of the analogue material.

5. The pet food of claim 1, wherein said slices make up between 50% and 100% by mass of the solid material in the package.

6. The pet food of claim 5, wherein said slices make up about 75% by mass of the solid material in the container.

7. The pet food of claim 1, wherein said slices consist of a loaf that has been sliced and placed in a pet food container such that the individual slices remain upright in side-by-side arrangement.

8. The pet food of claim 1, wherein the packaged pet food product incorporates slices of different types of meat that are interleaved and stacked or shingled in alternative order.

9. The pet food of claim 1, wherein said packaged pet food product further includes one or food products selected from the group consisting of vegetables, rice and pasta.

10. The pet food of claim 1, wherein the packaged pet food contains a plurality of meat analogue slices; and wherein the slices are arranged in a stack of partially overlapping individual slices; and
wherein this stack of slices is arranged in the container such that at least part of the majority of each of the individual slices is visible upon opening the container.

11. The pet food of claim 10, wherein the number of slices in the container is between 5 and 10.

12. The pet food of claim 11, wherein the number of slices in the container is 7.

13. The pet food product of claim 1, wherein the container is a tray of food having a content capacity in the range 85 g-100 g; and the dimensions of the slices are about 19-26 mm wide, 43-52 mm long and 2-7 mm thick.

14. A method of manufacturing packaged pet food products, comprising the steps of:
providing two or more slices of meat or meat analogue material in a sauce or gel:
providing a conatiner:
placing discretely apportioned pieces of said meat or meat analogue product in said container in a side-by-side stacked or shingled arrangement that is visually noticeable upon opening the container.

15. The pet food of claim 1, wherein the container is a can or tray.

16. The method of claim 14, wherein the container is a tray with a removable peel-off lid.
